(19) United States
(12) Patent Application Publication
(10) Pub. No.: US 2006/0200964 A1
(43) Pub. Date: Sep. 14, 2006

(54) Appliance recycling process

(75) Inventors: Edward Ronald Cameron, Minneapolis, MN (US); Richard Gordan Christensen, Osceola, WI (US)

Correspondence Address: VIDAS, ARRETT & STEINKRAUS, P.A., 6109 BLUE CIRCLE DRIVE, SUITE 2000, MINNETONKA, MN, 55343-9185, US

(73) Assignee: ARCA, Inc., Minneapolis, MN (US)

(21) Appl. No.: 11/077,263

(22) Filed: Mar. 10, 2005

(51) Int. Cl. H01B 15/00; B07B 13/00; B01D 19/00

(52) U.S. Cl. 29/403.3; 241/68; 96/155

(57) ABSTRACT

A method of recycling substantially all materials in a major household appliance comprises the steps of placing the appliance on a slip-sheet. Then, the slip-sheet and the appliance are transported along a conveyor system through a plurality of spaced stations. Then various materials are removed from the appliance and stored for recycling or disposal. At least one station has a band saw to saw the appliance into a plurality of pieces. At one station polyurethane foam is removed from the appliance. The removed polyurethane foam is then placed into a bag. The bag containing the polyurethane foam is then sealed, and the sealed bag is then vacuum packed.

### BACKGROUND

Most major household appliances, such as refrigerators and freezers, contain environmentally harmful substances that must be located, removed and managed properly during appliance disposal. A variety of methods and techniques have heretofore been used in the process of demanufacturing the appliances and recycling or disposing of the residual materials.

For many years, CFC-11 (trichlorofluoromethane) was used as a blowing agent in the manufacture of polyurethane foam, frequently used as insulating material in refrigerators and freezers. Rigid foam insulation was produced by injecting CFC-11 into a liquid mass of plastic polymer, creating the bubbles that provided the material's insulating capabilities.

Over time, a portion of the CFC-11 in the polyurethane foam insulation of refrigerators and freezers degasses naturally and escapes into the atmosphere, contributing to ozone depletion. Additionally, some of the CFC-11 migrates to the matrix structure of the foam and will not be released until the foam decomposes (approximately 100-200 years), is incinerated, or is processed to recover the CFC-11.

Technology to process polyurethane foam to recover the CFC-11 remaining in the material includes the ARCA/Adelmann A-55 system, which has proven to be highly effective. The ARCA/Adelmann A-55 has been certified to recover 99.0 percent of the CFC-11 found in newly manufactured polyurethane foam, and subsequent tests show that the equipment recovers 98.03% of the CFC-11 in aged foam.

The polyurethane foam insulation found in refrigerators and freezers is placed into a pneumatically sealed chamber in the ARCA/Adelmann A-55 system. The foam is fed into a high-compression chamber where it is shredded by rotary cutters, releasing the CFC-11 from the foam and capturing it in a negative-pressure, multi-stage condensation unit. The A-55 uses a high-density press to reduce the volume of polyurethane foam by a 30 to 1 ratio and remove any CFC-11 not liberated during the shredding process. The recovered CFC-11 is sent to a licensed recycler for reclamation and reuse.

Although ARCA/Adelmann A-55 or similar technology is available commercially, acquisition of the equipment is cost prohibitive for many recyclers of major household appliances. Therefore, incineration of the recovered CFC-11 and residual insulation material becomes a more practical option at present for managing polyurethane foam that has been removed from refrigerators and freezers during appliance processing and recycling.

The present invention provides improvements in the packaging methods and destruction through high-temperature incineration of CFC-11 and residual materials contained in the polyurethane foam insulation of refrigerators and freezers, and in recycling or otherwise disposing of other materials recovered from refrigerators and freezers. This is accomplished through a system and techniques that recover and recycle virtually all materials used in the manufacture of refrigerators and freezers, employing a packaging method that allows for more efficient and economical transporting of the foam for incineration.

The refrigerator or freezer to be processed and recycled is set onto a slip-sheet in a vertical position before being placed onto a roller conveyor system. The refrigerator or freezer is then transported through a series of processing stations in the system at which various hazardous components and materials therein are removed for recycling, disposal or destruction. The refrigerator or freezer is then placed in a horizontal position on the conveyor and sent to a band saw where the appliance shell is cut into a minimum of three pieces to allow the polyurethane foam to be separated from the remainder of the appliance. The polyurethane foam is then processed to capture the CFC-11 contained therein, which may be either recycled for reuse or incinerated, or is packaged in its entirety, without processing, for shipment to a high-temperature incineration facility for destruction.

Therefore, it can be seen that the present invention meets an existing need in the art for a more efficient and economical method and system for recovering, and/or processing, and transporting for incineration the polyurethane insulating foam and the CFC-11 contained therein.

All U.S. patents and applications and all other published documents mentioned anywhere in this disclosure are incorporated herein by reference in their entirety.

Without limiting the scope of the invention a brief summary of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well for the purposes of complying with 37 C.F.R. 1.72.

### SUMMARY

In at least one embodiment, a method of recycling substantially all materials in an appliance may comprise the steps of placing the appliance on a slip-sheet and transporting the slip-sheet and the appliance along a conveyor system through a plurality of spaced stations where various materials are removed from the appliance and stored for recycling or disposal. In at least one embodiment, the plurality of stations include a station having a band saw to saw the appliance into a plurality of pieces. In at least one embodiment, at least one station removes polyurethane foam; the foam then placed in at least one bag and vacuum packed.

In at least one embodiment, an additional step may be included wherein the gases from the vacuum packing step may be exhausted through a carbon filter; the carbon filter capable of trapping CFCs. In at least one embodiment, the carbon filters may then be incinerated. In at least one embodiment, the carbon filters may be incinerated only after having at least 80% of their capacity filled.

In at least one embodiment, at least one bag is constructed of a thermoplastic polymer. In at least one embodiment, at least one bag is 2.5 to 3 mil coextrusion nylon and vinyl or any other type of airtight material that can be sealed.

In at least one embodiment, the bags are sealed by a heat sealer, the heat sealer being either an automatic or manual heat sealer.

In at least one embodiment, the sealed bags may be transported to another location for further processing.

In at least one embodiment, the vacuum packed bags may be shredded in a shredder. In at least one embodiment, the shredding may be done under negative pressure such that CFCs released to the atmosphere are reduced. In at least one embodiment, the amount of CFCs is minimized. In at least one embodiment, during the shredding step the CFC gases may be exhausted through a carbon filter. The carbon filter is capable of trapping CFCs. In at least one embodiment, the carbon filter and the CFCs trapped therein are incinerated.

In at least one embodiment, after vacuum packing the sealed bags, the sealed bags may be chemically processed, reducing the CFCs into their constituent parts. In at least one embodiment, only the CFCs are chemically processed in this manner. In at least one embodiment, the foam containing the CFCs may be chemically processed.

In at least one embodiment, at least one bag is sealed against leakage of CFC-11. In at least one embodiment, the bag and the polyurethane foam are incinerated.

In at least one embodiment, gases from the foam are recovered after the foam has been vacuum packed. In at least one embodiment, the recovered gases are sent through a charcoal filter such that remaining CFCs bond to the charcoal filter contents.

In at least one embodiment, the charcoal filter is incinerated.

In at least one embodiment, a process to recycle substantially all materials in an appliance may comprise placing an appliance on a slip-sheet and transporting the slip-sheet and the appliance along a conveyor system to a plurality of stations. In at least one embodiment a hole may be drilled, cut, or punched into the compressor in the appliance and the oil drained from the compressor through the drilled or punched hole. In at least one embodiment, the oil is processed using a degassing apparatus having a degassing chamber, a high pressure oil pump, atomizing nozzles, and a vacuum pump. In at least one embodiment, the degassing chamber may have an oil level and an air space. In at least one embodiment, the oil pump may be submerged beneath the oil level and capable of pumping the oil through atomizing nozzles. In at least one embodiment, the atomizing nozzles are located in the air space above the oil level. In at least one embodiment, the vacuum pump is capable of removing a gas mixture including air and gaseous CFCs from the air space of the degassing chamber.

In at least one embodiment, the CFCs may be removed from the gas mixture by sending the gas mixture through a charcoal filter capable of trapping CFCs. In at least one embodiment, the charcoal filter and CFCs therein may be incinerated.

In at least one embodiment, after the gas mixture has been removed from the degassing chamber, the CFCs may be recovered by condensing the CFCs into liquid form. The condensed CFCs may then be stored and/or used again.

In at least one embodiment, the drained oil may be transferred into containers for shipment to recyclers.

In at least one embodiment, the carbon and/or carbon filters, through which the air from the degasser is filtered, may be vacuum packed after having removed CFCs from the gas or air. In at least one embodiment, the carbon and/or carbon filters may be incinerated.

In at least one embodiment, an apparatus for degassing oil may comprise a degassing chamber, a high pressure oil pump, atomizing nozzles, and a vacuum pump. In at least one embodiment, the degassing chamber may have oil, an oil level, and an air space. In at least one embodiment, a high pressure oil pump may be submerged beneath the oil level and capable of pumping the oil through atomizing nozzles which may be located in the air space above the oil level. In at least one embodiment, a vacuum pump may be capable of removing the gases in the air space from the degassing chamber.

These and other embodiments which characterize the invention are pointed out with particularity in the claims annexed hereto and forming a part hereof. However, for a better understanding of the invention, its advantages and objectives obtained by its use, reference should be made to the drawings which form a further part hereof and the accompanying descriptive matter, in which there are illustrated and described embodiments of the invention.

### DESCRIPTION of DRAWINGS

FIG. 1 is a schematic block diagram view of an embodied process.

FIG. 2 is a schematic block diagram view of how the vacuum packed bags may be further processed.

FIG. 3 is a schematic block diagram view of how the oil may be further processed.

FIG. 4 is a front view of the degassing apparatus.

### DETAILED DESCRIPTION

While this invention may be embodied in many different forms, there are described in detail herein specific embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

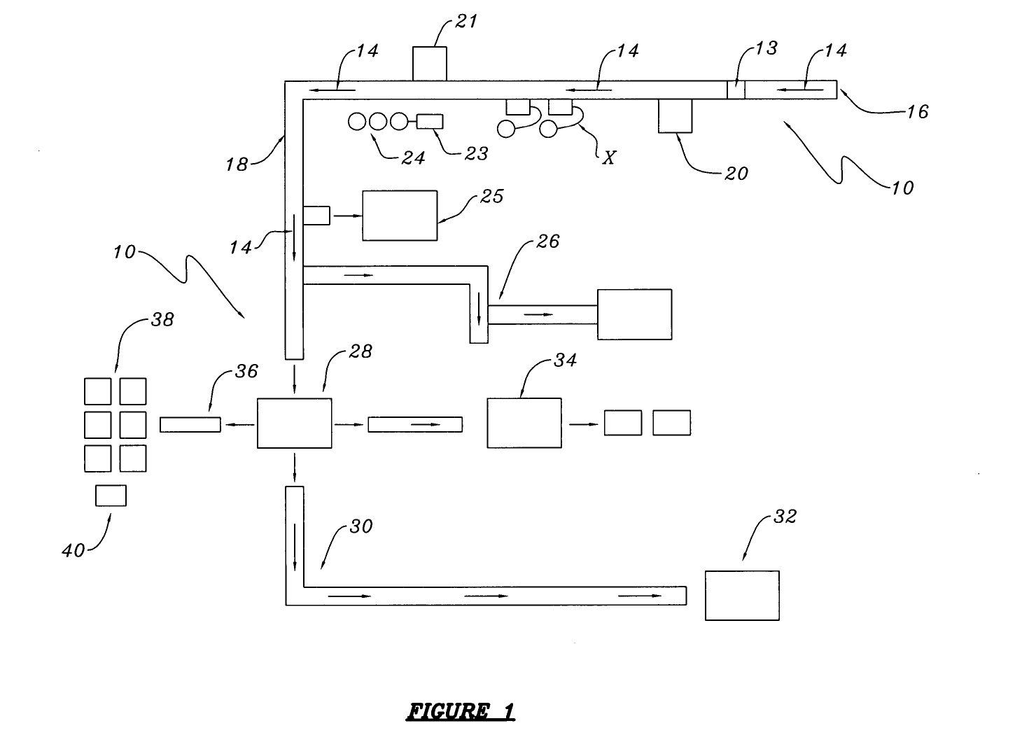

Referring to FIG. 1, a schematic block diagram view of at least one embodied process is shown. The appliance may be placed on a slip-sheet or pallet 13 where it may then be placed onto a conveyor system 10, preferably in a vertical or upright position. The holder or slip-sheet placed on the conveyor system 10 for movement in the direction of the arrows 14. The conveyor, system 10 may be of any desired width, such as approximately 3½ feet, to accommodate the slip-sheet 13 and appliance loaded thereon. The slip-sheet 13 is preferably about 3 feet square and may be of any desired thickness, such as approximately ¾-inch thick plywood or plastic, so as to be easily carried along the system 10 as the refrigerator or other appliance thereon is moved through the system to remove and recover the materials therein.

The slip-sheet 13 and refrigerator or other appliance are placed on the system 10 at a starting point or end 16 in a first portion or section 18. The slip-sheet 13 and refrigerator or other appliance are moved to a first station 19 where hazardous and/or environmentally harmful components, such as capacitors, mercury switches, ballasts and batteries, are removed and stored for shipping and disposal or recycling according to all applicable governmental regulations.

The slip-sheet 13 and appliance are moved to a second station 20 where CFC, HCFC (hydrochlorofluorocarbon) or HFC (hydrofluorocarbon) refrigerant is evacuated from the refrigerator or other appliance in any approved or known manner and pumped into tanks for shipping to a reclamation facility.

A compressor in the refrigerator or other appliance has a hole formed therein, as by drilling or punching. The hole is of sufficient size to enable the compressor to be drained, and the slip-sheet 13 and appliance are moved to a third station 21 having a pneumatic tilting platform to tilt the slip-sheet 13 and appliance to an angle of approximately 90 degrees. The oil 22 in the compressor gravity drains into a holding tank 23.

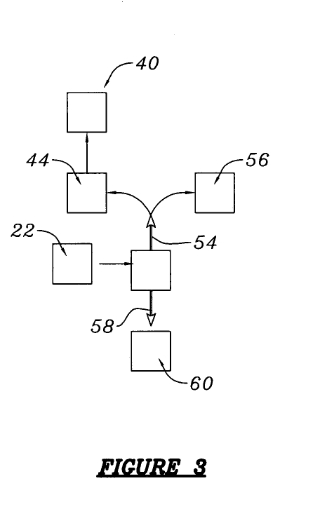

The oil is transferred to a degasser 52. The degasser is designed, as shown in FIG. 3, to remove air and CFCs from the oil 22. The stream 54 of air and CFCs may be processed in at least two ways. The stream 54 may be sent to a condenser 56 where the CFCs are condensed out of the stream 54 and separated from the air. These CFCs may be reclaimed for reuse. Alternatively, the stream 54 may be sent through a carbon filter system having carbon filters 44. The carbon filters 44 are then incinerated in the incinerator 40 and the air may be released to the environment.

Interior parts are removed from the refrigerator or other appliance and sent to a glass bin at 24 or a plastic and metal interior flow conveyor portion 26 for appropriate storage and/or processing. The interior parts removal may be done on the conveyor portion 18, elevated from the supporting surface 12, or the slip-sheet 13 and refrigerator or other appliance thereon may be lowered to ground level for convenience.

After the interior parts are removed and the slip-sheet and refrigerator or other appliance are at ground level, the refrigerator or other appliance is moved so as to lay or rest horizontally on the conveyor system 10. The refrigerator or other appliance is then moved to device 28, such as a large band saw, to break or form the refrigerator or other appliance into several pieces. The large band saw 28 is sized and dimensioned to enable a large refrigerator or freezer to be easily held therein and be cut into a plurality of pieces or sections. The band saw 28 includes a specifically designed set of pneumatic clamps for securely holding a refrigerator, or the like, during cutting. This clamping device also tilts the refrigerator or other appliance to approximately 10 degrees from horizontal to allow a saw blade in the band saw to more easily cut the refrigerator or other appliance into pieces or sections. This tilting also preserves blade life.

The band saw 28 preferably cuts the refrigerator into three or more pieces by making one cut through the refrigerator spaced approximately 18″ to 24″ from the bottom of the appliance, one cut approximately 2″ to 3″ from the top of the refrigerator, and one cut approximately 2″ to 3″ from the front of the refrigerator.

After being cut into two or more pieces or sections, each piece or section is taken apart, by machine or manually, by stripping away the metal shell and any interior plastic liner and pulling or scraping the polyurethane foam from the metal and/or plastic. The metal is sent to a further portion or section 30 of the conveyor to system, where it may be compacted and then collected at 32, for forwarding to a recycler.

The interior plastic liner, together with any other plastic taken from the interior is sent to a plastic chipper 34, where it is shredded into manageable size pieces for sorting, storing, packaging and shipment to a plastic recycler.

The polyurethane foam is packaged at 36 into airtight bags and sealed to prevent any further release of CFC-11. The sealed bags may then be vacuum packed.

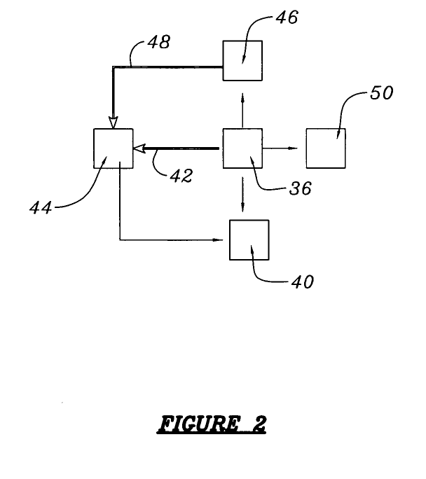

FIG. 2 illustrates how the vacuum packed polyurethane foam 36 may be further processed. In at least one embodiment, the vacuum packed polyurethane 36 is then incinerated in incinerator 40. In at least one embodiment, the gases removed during the vacuum packing are sent through a carbon filter system having carbon filters 44. The carbon filters 44 are then incinerated in the incinerator 40 as is the carbon vacuum packed polyurethane 36.

In at least one embodiment, the vacuum packed polyurethane 36 is further shredded in shredder 46. In at least one embodiment, negative pressure is applied to the released gases 48 such that the gases 48 are sent through a carbon filter system having carbon filters 44. The carbon filters 44 are then incinerated in the incinerator 40 as is the shredded carbon vacuum packed polyurethane from shredder 46.

In at least one embodiment, the vacuum packed polyurethane 36 is further processed chemically at chemical processing station 50.

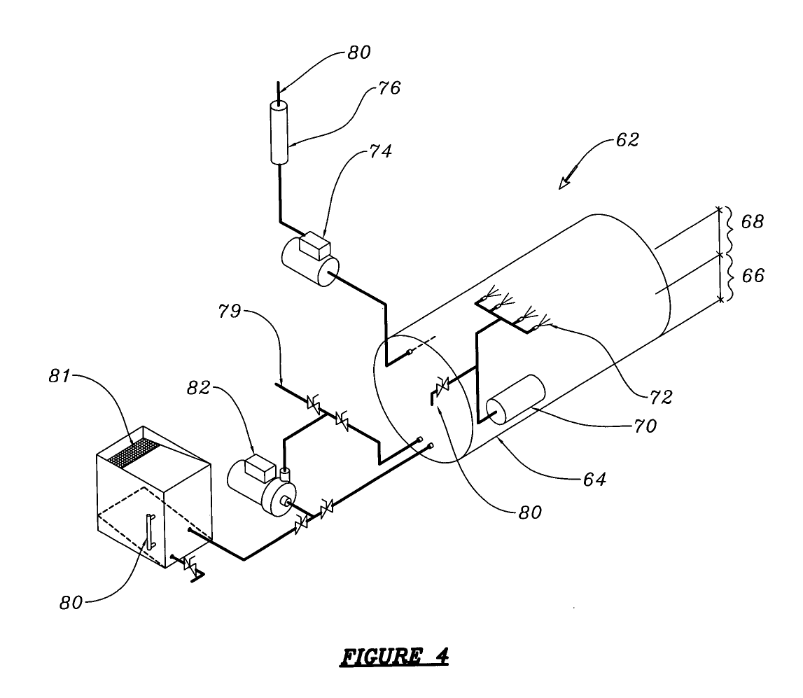

FIG. 3 illustrates how oil 22 may be further processed. In at least one embodiment, the oil is transferred to a degasser 52. The degasser is designed, as shown in FIG. 4, to remove air and CFCs from the oil 22. The stream 54 of air and CFCs may be processed in at least two ways. In at least one embodiment, the stream 54 is sent to a condenser 56 where the CFCs are condensed out of the stream 54 and separated from the air. These CFCs may be reclaimed for reuse. In at least one embodiment, the stream 54 is sent through a carbon filter system having carbon filters 44. The carbon filters 44 are then incinerated in the incinerator 40 and the air may be released to the environment.

In at least one embodiment, the stream 58 of degassed oil is then sent to recyclers 60 for further processing.

In FIG. 4 the degassing apparatus 62 is illustrated. The degassing apparatus includes a degassing chamber 64 which may have, in at least one embodiment, an oil level 66 and an air space 68 above the oil level. The oil level 66 may in some embodiments be only one half to one third of the entire fluid capacity of the degassing chamber 64. In some embodiments a 500-gallon degassing chamber may contain only 175 to 225 gallons of oil to be processed. Level switches and relays may be used to control the oil level. An oil pump 70 may be submerged beneath the oil level 66. In some embodiments, this may be an internal high pressure oil pump. In some embodiments, the oil pump may be disposed outside the degassing chamber 64. The pump 70 forces the oil through internal atomizing nozzles 72 which are above the oil level 66 and may be located at the top portion of the air space 68 within the degassing chamber 64. The atomizing nozzles 72 are capable of separating air, CFCs, and other gases from the oil.

In at least one embodiment, a vacuum pump 74 may be in fluid communication with the air space 68 within the gas chamber 64. The vacuum pump is capable of removing a gas mixture including air and gaseous CFCs from the air space of the degassing chamber and sending the gas mixture through a charcoal filter which filters CFCs from the gas mixture and releases the remaining air through the clean air exhaust 78.

The oil 22 within the degassing chamber 64 is tested continually or at set intervals through the test port 90. From the test port 90 small portions of the oil from the degassing chamber 64 may be extracted in order to determine whether the concentration of CFCs in the oil has been reduced to an acceptable ratio. In at least one embodiment, when the CFC content in the oil is less than 1,000 PPM the process is stopped. At this point the oil may be disposed of through an oil disposal line 79. More dirty oil 22 from the oil retrieval step may then be processed through the degassing apparatus 62. Before the oil 22 enters the degassing chamber 64 it is first strained through a strainer 81 of a settling tank 80. After it is strained, a pump 82 may transfer the strained dirty oil 22 from the settling tank 80 to the degassing chamber 64. Then the process separating the CFCs from this oil 22 is started anew.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to.” Those familiar with the art may recognize other equivalents to the specific embodiments described herein which equivalents are also intended to be encompassed by the claims.

The particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below (e.g. Claim 8 may be taken as alternatively dependent on claim 7, or on claim 6; claim 9 may be taken as alternatively dependent from any of claims 8, claim 7 or claim 5; etc.).

This completes the description of the embodiments of the invention. Those skilled in the art may recognize other equivalents to the specific embodiment described herein which equivalents are intended to be encompassed by the claims attached hereto.

What is claimed is:

1. A method of recycling substantially all materials in an appliance, comprising the steps of:
placing the appliance on a slip-sheet;
transporting the slip-sheet and the appliance along a conveyor system through a plurality of spaced stations, where various materials are removed from the appliance and stored for recycling or disposal; at least one of the plurality of stations includes a station having a band saw to saw the appliance into a plurality of pieces;
removing polyurethane foam from the appliance at one of the plurality of stations;
placing the removed polyurethane foam into a bag made of a thermoplastic polymer;
sealing the bag containing the polyurethane foam; and
vacuum packing the sealed bag.

2. The method of claim 1, wherein the thermoplastic polymer is selected from the group consisting of nylon, vinyl, polyurethane, or any combination thereof.

3. The method of claim 1, including the further step of exhausting the gases from the vacuum packing step through a carbon filter, the carbon filter capable of trapping CFCs.

4. The method of claim 3, including the further step of incinerating the carbon filter after trapping CFCs.

5. The method of claim 4, wherein the carbon filters are incinerated only after having at least 80% of their capacity filled.

6. The method of claim 1, wherein the bag is a 2.5 to 3 mil bag constructed of coextruded nylon and vinyl.

7. The method of claim 1, wherein the bag is sealed by a heat sealer.

8. The method of claim 1, including the further step of transporting the sealed bag to another location for further processing.

9. The method of claim 8, including the further step of shredding the sealed, vacuum packed bags through a shredder.

10. The method of claim 9, including the further step of applying a negative pressure to the gases and CFCs released during shredding and exhausting the gases and CFCs through a carbon filter which traps the CFCs.

11. The method of claim 10, including the further step of incinerating the carbon filter and the trapped CFCs therein.

12. The method of claim 8, including the further step of chemically processing the sealed bags and chemically reducing the CFCs into their constituent parts.

13. The method of claim 8, including the further step of incinerating the sealed bags.

14. A process to recycle substantially all materials in an appliance, comprising the steps of:
placing the appliance on a slip-sheet;
transporting the slip-sheet and the appliance along a conveyor system to a plurality of stations;
forming a hole in a compressor in the appliance;
draining oil from the compressor through the hole;
processing the oil using a degasser, the degasser having a degassing chamber, the degassing chamber having an oil level and an air space; a high pressure oil pump submerged beneath the oil level and pumping the oil through atomizing nozzles which are located in the air space above the oil level; a vacuum pump removing a gas mixture including air and gaseous CFC from the air space of the degassing chamber for further processing of the gas mixture.

15. The process of claim 14, including the further steps of removing the CFCs from the gas mixture by sending the air and CFC mixture through a charcoal filter capable of trapping CFCs.

16. The process of claim 15, including the further step of incinerating the charcoal filter and CFCs therein.

17. The process of claim 14, including the further step of recovering the CFCs by condensing the CFCs into liquid form.

18. The process of claim 14, including the further step of placing the oil from the degasser into containers for shipment to recyclers.

19. The process of claim 14, wherein the appliance is placed on the slip-sheet in an upright or vertical position, the platform tilting the appliance during the draining oil step.

20. The process of claim 15, including the further step of vacuum packing the carbon and the CFCs trapped therein.

21. The process of claim 20, including the further step of incinerating the vacuum packed carbon.

22. An apparatus for degassing oil comprising:
a degassing chamber, the degassing chamber having an oil level and an air space;
a high pressure oil pump submerged beneath the oil level and capable of pumping the oil through atomizing nozzles which are located in the air space above the oil level;
a vacuum pump capable of removing the gases in the air space from the degassing chamber.
